(19) United States
(12) Patent Application Publication
(10) Pub. No.: US 2026/0221126 A1
(43) Pub. Date: Jul. 30, 2026

(54) Piezoelectric Pickup Integrated with a Floyd Rose Locking Nut Assembly

(71) Applicant: Dean Bowes, Mableton, GA (US)

(72) Inventor: Dean Bowes, Mableton, GA (US)

(21) Appl. No.: 19/452,765

(22) Filed: Jan. 19, 2026

(51) Int. Cl. G10H 3/14; G10D 3/04; G10H 1/00; G10H 1/46; G10H 3/18

(52) U.S. Cl. CPC G10H 3/143; G10D 3/04; G10H 1/0083; G10H 1/46; G10H 3/181; G10H 2220/565

(57) ABSTRACT

A piezoelectric pickup system integrated with a Floyd Rose locking nut for electric guitars, capturing string vibrations directly at the nut location. The system positions a piezo element beneath the nut's clamping blocks, aligned with the locking screws to maintain tuning stability and tremolo functionality. Electrical output from the piezo element is routed to an amplifier, signal processor, or wireless transmitter, enabling acoustic-style tonal capture independent of bridge pickups. The pickup is easily installed without modifying the original nut or clamping mechanism. Optional features include volume control, preamplification, noise-reduction shielding, and wireless transmission. This system provides a novel, mechanically robust method to capture string vibrations at the headstock, offering guitarists expanded tonal versatility and performance capabilities previously unavailable with floating bridge systems.

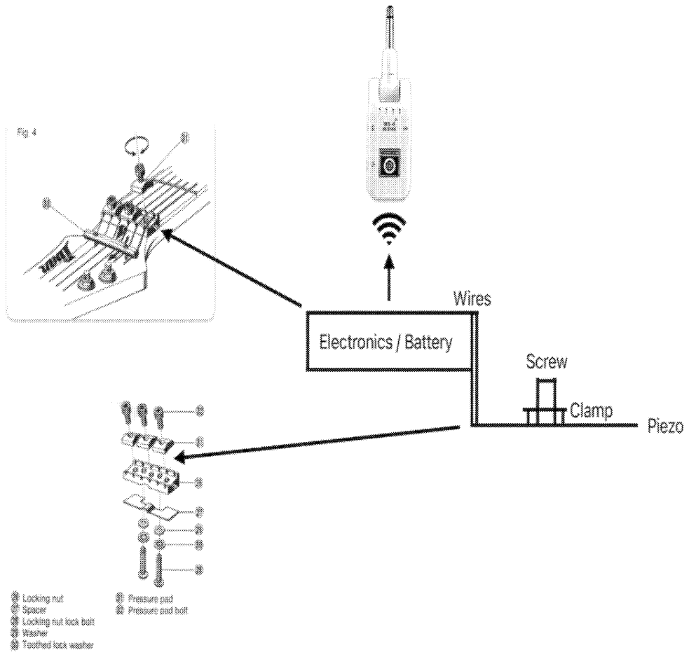

### FIELD OF THE INVENTION

The present invention relates to guitar pickup systems for electric guitars. More specifically, the invention pertains to a piezoelectric pickup system mechanically integrated with a Floyd Rose-type locking nut assembly, configured to capture string vibrations at the nut without altering the function or structure of the locking nut mechanism.

### BACKGROUND OF THE INVENTION

Electric guitars commonly employ pickups positioned at or near the bridge or beneath the strings along the guitar body to convert string vibration into electrical signals. Piezoelectric pickups, in particular, are widely used in bridge or saddle-mounted configurations to produce acoustic-style tonal characteristics by sensing string vibration transmitted through the bridge structure.

Guitars equipped with Floyd Rose-type tremolo systems incorporate a locking nut assembly at the headstock end of the instrument. The locking nut clamps each string between a clamping block and a nut base using threaded fasteners, thereby preventing string slippage and maintaining tuning stability during tremolo operation. The locking nut is designed primarily for mechanical stability and tuning performance, and has traditionally been treated as a passive structural component rather than as a signal capture point. Existing piezoelectric pickup systems are not designed for installation at the locking nut of a Floyd Rose tremolo system. Bridge-mounted piezo pickups are generally incompatible with floating tremolo designs or fail to provide consistent acoustic-style output when used in conjunction with such systems. As a result, electric guitars equipped with Floyd Rose tremolo systems typically lack a practical means of capturing string vibration at the nut or producing a dedicated acoustic-style signal independent of magnetic pickups. The locking nut environment presents unique mechanical constraints that have discouraged prior pickup integration. These constraints include the need to preserve precise string clamping pressure, maintain screw alignment and torque, avoid interference with string seating, and prevent any modification that could compromise tuning stability or tremolo performance. For these reasons, prior art has focused on bridge-based pickup solutions rather than nut-based signal capture.

Accordingly, there exists a need for a piezoelectric pickup system that can be mechanically integrated with a Floyd Rose locking nut assembly in a non-invasive manner, preserves the original locking function, and captures string vibrations directly at the nut to produce an acoustic-style output signal. The present invention addresses this need by providing a piezoelectric pickup configuration specifically adapted for installation beneath the locking nut clamping elements without altering the locking nut structure or operation.

### SUMMARY OF THE INVENTION

The present invention provides a piezoelectric pickup system configured for mechanical integration with a Floyd Rose-type locking nut assembly on an electric guitar. The pickup system is positioned beneath one or more locking nut clamping elements such that string vibration is transferred directly to the piezoelectric element at the nut location, while the original locking function of the nut remains unchanged.

In one embodiment, the piezoelectric pickup comprises a thin pickup element shaped to fit between the locking nut clamping blocks and the nut base. The pickup element includes openings aligned with the locking nut fasteners, allowing the existing locking screws to pass through the pickup without modification. When the locking screws are tightened, the clamping blocks secure the strings while simultaneously coupling string vibration into the piezoelectric element.

The pickup system converts the captured string vibrations into an electrical signal representative of the acoustic characteristics of the strings at the nut. The electrical signal may be routed through a dedicated output path separate from magnetic pickups, enabling acoustic-style amplification, recording, or signal processing.

The pickup system may further include associated electrical components such as volume controls, output jacks, or signal conditioning circuitry. In certain embodiments, the pickup output may be transmitted via a wired or wireless connection. These additional components are configured so as not to interfere with the mechanical operation, tuning stability, or tremolo performance of the Floyd Rose locking nut system.

By integrating a piezoelectric pickup directly into the locking nut assembly without altering its structure or function, the present invention enables nut-based acoustic signal capture on guitars equipped with floating tremolo systems, which has not been previously achievable using conventional pickup designs.

### DETAILED DESCRIPTION OF THE INVENTION

The invention comprises a piezoelectric pickup system mechanically integrated with a Floyd Rose-type locking nut assembly. The detailed description is provided with reference to the mechanical configuration, installation, and operational aspects of the system.

### 1. Locking Nut Structure

A typical Floyd Rose locking nut assembly includes:
A nut base secured to the guitar neck at the headstock end.
Multiple clamping blocks, one per string, aligned with the strings.
Threaded fasteners (locking screws) passing through the clamping blocks into the nut base to lock each string in position.

The clamping blocks maintain constant string pressure to prevent tuning slippage during tremolo operation. The assembly is designed to withstand significant torque applied during string locking while preserving string height, intonation, and alignment.

### 2. Piezoelectric Pickup Element

The piezoelectric pickup is a thin, mechanically compliant element positioned between the clamping blocks and the nut base. Key structural features include:
Form Factor: The element is sized to fit entirely within the footprint of the nut assembly without interfering with the clamping blocks or strings.
Screw Alignment Openings: The element includes openings aligned with each locking screw, allowing screws to pass through without obstruction.
String Contact Surface: The piezo element is positioned to maximize mechanical coupling with the clamping blocks, ensuring efficient transfer of string vibration.
Electrical Connectivity: Electrical leads or connectors extend from the pickup element to a volume control, output jack, or optional conditioning circuitry.

### 3. Installation Procedure

1 Remove existing locking screws and clamping blocks if necessary.
2 Place the piezoelectric pickup element on the nut base, aligning the openings with the screw holes.
3 Reinstall the clamping blocks over the pickup element.
4 Insert and tighten the existing locking screws to secure the clamping blocks, compress the pickup element, and lock the strings.
5 Connect the pickup leads to the output path, which may include a volume control, dedicated output jack, or optional wireless transmitter.

### 4. Operation

Upon string vibration during play, the clamping blocks transmit mechanical energy to the piezoelectric element. The element converts the vibrations into an electrical signal representing the acoustic characteristics of the strings at the nut location. The signal can be routed to an amplifier, recording device, or signal processing unit.

The installation and operation of the pickup system do not alter the mechanical function of the locking nut, do not compromise tuning stability, and do not interfere with tremolo operation.

### 5. Optional Electrical Enhancements

The system may optionally include:
Integrated volume controls to adjust the output level of the pickup.
Signal conditioning circuitry to tailor the tonal characteristics.
A dedicated output jack for acoustic-style amplification.
A wireless transmitter/receiver module for cable-free signal routing.

All optional enhancements are designed to coexist with the mechanical structure of the locking nut without affecting its operation or stability.

### Alternative Embodiments

While the primary embodiment of the invention positions the piezoelectric pickup element beneath standard Floyd Rose locking nut clamping blocks, the system may be implemented in the following alternative configurations without departing from the scope of the invention:

### 1 Material Variations

The piezoelectric element may be fabricated from various piezo materials, including ceramic, polymer, or composite piezo sheets.
The nut base or clamping blocks may be constructed from metal, synthetic polymers, composite materials, or wood, provided that string vibration is adequately transmitted to the piezo element.

### 2 Form Factor Adjustments

The piezo element may be manufactured in different thicknesses or shapes to accommodate variations in Floyd Rose locking nut designs.
Elements may be segmented for individual strings, allowing independent vibration capture per string, or may be continuous for all strings.

### 3 Electrical Integration Options

Optional preamplification or signal conditioning may be embedded within the pickup element or positioned externally.
Signal output may be routed via standard ¼″ or ⅛″ jacks, or via integrated wireless transmitters (2.4 GHz, Bluetooth, or RF).
A volume control or mini-mixer may be incorporated for direct on-nut adjustment.

### 4 Installation Variants

The system may be installed in existing nuts with minimal modification, or included as part of factory-installed Floyd Rose locking nut assemblies.
The screw alignment and clamping function remain unchanged, preserving original tuning stability and tremolo operation.

### 5 Optional Enhancements

Noise-reduction shielding may be incorporated to minimize electromagnetic interference.
Surface treatments or coatings may be applied to enhance durability or tonal characteristics.

Each alternative embodiment maintains the core inventive concept: a piezoelectric pickup mechanically integrated with a Floyd Rose locking nut, capturing string vibrations at the nut location while leaving the original locking and tremolo function intact.

### Conclusion

The invention transforms the traditionally passive Floyd Rose locking nut into an active signal capture interface, allowing direct string vibration detection at the nut without affecting tuning stability. By integrating a piezoelectric element beneath the clamping blocks, this system delivers high-fidelity, acoustic-like tonal output, whether via wired or wireless signal paths. Its precise mechanical design, retrofit installation, and optional enhancements ensure broad applicability across Floyd Rose-equipped guitars. This approach provides a novel, non-obvious, and highly functional solution to a long-standing gap in guitar technology, enabling musicians to achieve expressive tonal control not possible with existing bridge-mounted pickup systems.

1. A piezoelectric pickup system integrated with a Floyd Rose locking nut assembly on an electric guitar, the system comprising:
a. a nut base secured at the headstock end of the guitar;
b. a plurality of clamping blocks, one per string, each block aligned with a corresponding string;
c. threaded locking screws passing through the clamping blocks into the nut base to secure the strings;
d. a piezoelectric pickup element positioned between the clamping blocks and the nut base, the element comprising openings aligned with the locking screws to allow secure passage and retention of the clamping blocks; and
e. an electrical output coupled to the piezoelectric pickup element, configured to transmit a signal representing string vibrations captured at the nut location.

2. A method for capturing string vibrations on an electric guitar equipped with a Floyd Rose locking nut, comprising:
a. positioning a piezoelectric pickup element between the clamping blocks and the nut base of the locking nut;
b. aligning openings in the pickup element with the locking screws of the Floyd Rose locking nut;
c. securing the clamping blocks and locking screws over the pickup element to lock the strings in place while compressing the element; and
d. routing the electrical signal generated by the piezoelectric pickup element to an output for amplification or processing.

3. The system of claim 1, further comprising a volume control electrically coupled to the piezoelectric pickup element.

4. The system of claim 1, further comprising a dedicated output jack for transmission to an amplifier or signal processor.

5. The system of claim 1, wherein the piezoelectric pickup element is fabricated from ceramic, polymer, or composite materials.

6. The system of claim 1, wherein the piezoelectric pickup element is manufactured in multiple thicknesses or shapes to fit variations in Floyd Rose locking nut designs.

7. The system of claim 1, further comprising integrated preamplification or signal conditioning circuitry.

8. The system of claim 1, further comprising a wireless transmitter configured to output the signal without wired connection.

9. The system of claim 1, further comprising noise-reduction shielding to reduce electromagnetic interference.

10. The method of claim 2, wherein the electrical signal is optionally routed through a volume control, preamplifier, or wireless transmitter.

11. The method of claim 2, wherein the securing of the clamping blocks preserves tuning stability and tremolo function.
